(19) United States
(12) Patent Application Publication
(10) Pub. No.: US 2025/0137770 A1
(43) Pub. Date: May 1, 2025

(54) DISPLACEMENT DETECTION DEVICE

(71) Applicant: DMG MORI CO., LTD., Nara (JP)

(72) Inventors: Ken ONOE, Kanagawa (JP); Shingo SEKISAWA, Kanagawa (JP); Toyohiko MATSUDA, Kanagawa (JP)

(73) Assignee: DMG MORI CO., LTD., Nara (JP)

(21) Appl. No.: 18/834,608

(22) PCT Filed: Sep. 1, 2023
(86) PCT No.: PCT/JP2023/032068

§ 371 Date: Jul. 30, 2024

(30) Foreign Application Priority Data
Sep. 9, 2022 (JP) 2022-143592
Aug. 24, 2023 (JP) 2023-136327

(51) Int. Cl. G01B 3/22; G01B 5/20

(52) U.S. Cl. CPC G01B 3/22; G01B 5/20

(57) ABSTRACT

A displacement detection device includes a stylus, a rotating member that supports the stylus and rotates with a fulcrum as a base point when the stylus contacts measurement target, a shaft on which a scale is provided, an actuation conversion mechanism that converts the rotation of the rotating member upon contact of the stylus with the measurement target into axial motion of the shaft, and a sensor that detects displacement of the scale. The stylus is detachably attached to the rotating member.

### TECHNICAL FIELD

This invention relates to a displacement detection device that detects displacement by rotation of a stylus.

### BACKGROUND ART

Lever gauges (lever-type gauges) are known as displacement detection devices. Lever gauges are equipped with a stylus having a contactor, a scale that is displaced in the axial direction in conjunction with the rotation of the stylus, and a sensor that detects the displacement of the scale (see Patent Literature 1).

Such a lever gauge can measure the surface shape and displacement of the measurement target by converting the rotational displacement of the stylus when the stylus contacts the measurement target into the axial displacement of the scale and detecting the axial displacement. By bringing the stylus into contact with a workpiece held by the spindle of a machine tool and rotating the workpiece in this state, the axial runout of the workpiece can also be measured.

### Related Art List

Patent Literature 1: JP 2021-071376 A

### SUMMARY

### Technical Problem

In such a displacement detection device, the stylus extends forward from the case that houses the scale, and the contactor at its tip contacts the surface of the measurement target. The front end of the case has a bearing that serves as the fulcrum for stylus rotation. In such a configuration, it is necessary to bring the stylus into contact with a measurement target according to the structure of the measurement target to ensure measurement accuracy.

### Solution to Problem

A displacement detection device in one aspect of the present invention includes: a stylus, a rotating member that supports the stylus and rotates with a fulcrum as a base point when the stylus contacts a measurement target, a shaft on which a scale is provided, an actuation conversion mechanism that converts the rotation of the rotating member upon contact of the stylus with the measurement target into axial motion of the shaft, and a sensor that detects displacement of the scale.

The stylus is detachably attached to the rotating member.

### Advantageous Effects of Invention

The present invention can provide a displacement detection device capable of bringing the stylus into contact with a measurement target according to the structure of the measurement target and ensuring measurement accuracy.

### BRIEF DESCRIPTION OF DRAWINGS

FIG. 1 is a perspective view illustrating the external appearance of a displacement detection device according to an embodiment.

FIG. 2 is a view illustrating the internal structure of the measuring instrument.

FIG. 3 is a view illustrating the internal structure of the measuring instrument.

FIG. 4 is a cross-sectional view taken along A-A line of FIG. 3.

FIGS. 5A to 5C illustrate the configuration of a connecting member in detail.

FIGS. 6A to 6C illustrate the actions of a tilting mechanism.

FIGS. 7A to 7C illustrate the configuration and action of the stylus and its surroundings.

FIG. 8 schematically illustrates an actuation conversion mechanism and a displacement amplification mechanism.

FIGS. 9A and 9B schematically illustrate a second amplification mechanism that constitutes the displacement amplification mechanism.

FIGS. 10A and 10B schematically illustrate the principle of displacement amplification.

FIGS. 11A and 11B illustrate the differences in configuration between an embodiment and a comparative example. FIGS. 12A and 12B illustrate the details of the attachment/detachment structure of a stylus.

FIG. 13 is a functional block diagram of an information processing device.

FIG. 14 is a graph illustrating an example of an error between the length measured by a measuring instrument and the actual length.

FIG. 15 is a view illustrating a correction method performed during the replacement of a stylus. FIGS. 16A and 16B illustrate a correction method for stylus angular error.

### DESCRIPTION OF EMBODIMENTS

One embodiment of the invention will be described below with reference to the drawings. For convenience, the following description may express the positional relationship of each structure based on the state shown in the figures. In the following embodiments and modifications, nearly identical components will be marked with the same symbols, and their descriptions will be omitted as appropriate.

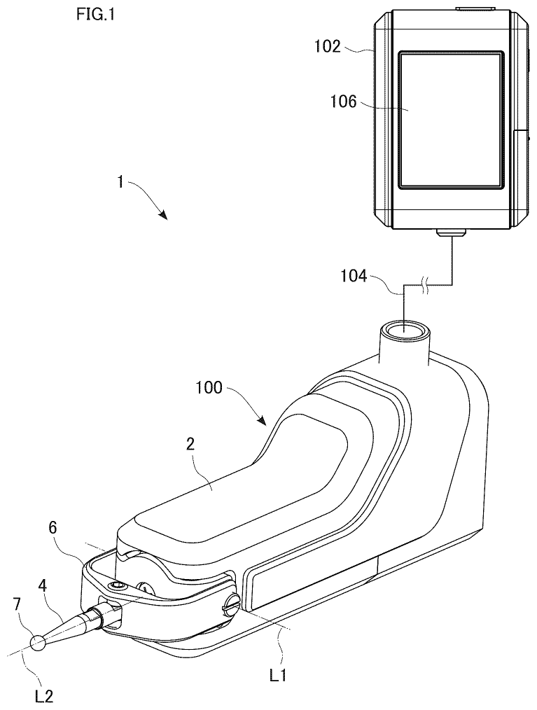

FIG. 1 is a perspective view illustrating the external appearance of a displacement detection device 1 according to an embodiment.

The displacement detection device 1 includes a measuring instrument 100 and an information processing device 102. The information processing device 102 is a device that processes information detected by the measuring instrument 100 and is connected to the measuring instrument 100 via a cable 104. The cable 104 functions as a power supply line and a communication line.

The information processing device 102 is provided with a monitor 106 for displaying measurement values measured by the measuring instrument 100 and other information. A touch panel is installed on the surface of the monitor 106, and the user can operate the information processing device 102 via the touch panel. The monitor 106 corresponds to the display unit 110 described below, and the touch panel corresponds to the input unit 112 described below (see FIG. 13).

The measuring instrument 100 includes a case 2 that houses internal mechanisms, a stylus 4 that has a contact portion that contacts a measurement target, and a support member 6 that supports the stylus 4. The support member 6 has an arch shape and is rotatable around a rotation axis L1 set with respect to the case 2. Both ends of the support member 6 are located on the rotation axis L1.

The stylus 4 is detachably attached to the center of the tip portion of the support member 6. The axis L2 of the stylus 4 is perpendicular to the rotation axis L1 of the support member 6. Both ends of the support member 6 are located on the sides of the case 2, respectively. The support member 6 can rotate about the rotation axis L1 and is supported in a manner that overhangs toward the front of the case 2. The stylus 4 has a spherical contactor 7 at its tip.

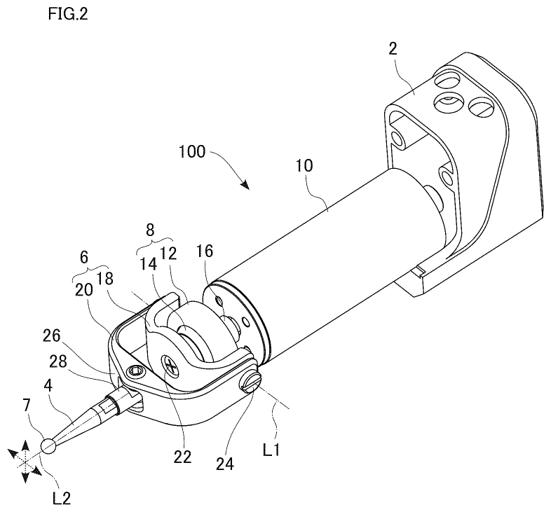

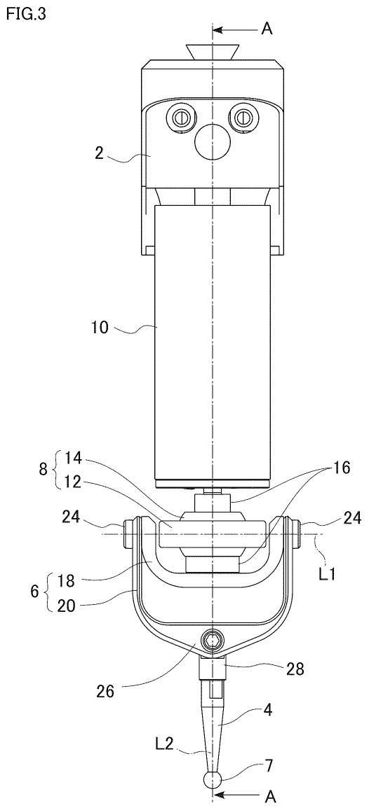

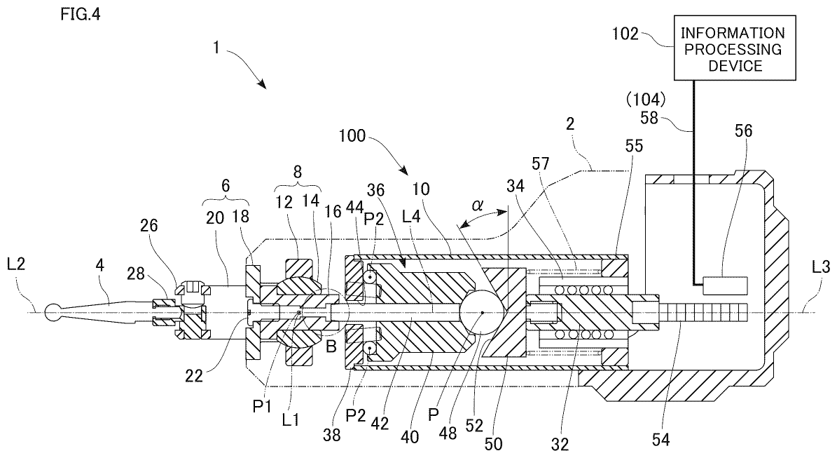

FIGS. 2 and 3 are views illustrating the internal structure of the measuring instrument 100. FIG. 2 is a perspective view, and FIG. 3 is a plan view. FIG. 4 is a cross-sectional view taken along A-A line of FIG. 3. Each figure shows the state in which a part of the case 2 is removed in the measuring instrument 100.

As shown in FIG. 2, a bearing 8 and a cylinder 10 are provided inside the case 2. The bearing 8 functions as a fulcrum (first fulcrum) for the support member 6 on the rotation axis L1. The cylinder 10 accommodates a scale or the like (see below). The bearing 8 is a spherical bearing in the present embodiment and includes an annular outer ring 12 and an inner ring 14 with a spherical outer surface. The outer ring 12 is fixed to the case 2. The inner ring 14 is connected to the inner mechanism of the case 2 via a connection portion 16.

As also shown in FIG. 3, the support member 6 has a joint portion 18 fixed to the connection portion 16 and a support portion 20 fixed to the joint portion 18. Both the joint portion 18 and the support portion 20 have an arch shape. The support member 6 has a double arch structure with the joint portion 18 as the inner arch and the support portion 20 as the outer arch. A bearing 8 is provided on the inside of the support member 6 (inside the arch shape).

Returning to FIG. 2, the center portion of the joint portion 18 is fastened to the connection portion 16 with a screw 22, and both ends of the support portion 20 are fastened to each end of the joint portion 18 with a screw 24 (an example of a “fastening member”). The axis of the screw 24 is located on the rotation axis L1. The axis L2 of the stylus 4 and the axis of the connection portion 16 are configured to be on the same axis when the joint portion 18 and the support portion 20 are fixed in a reference position where their front ends are parallel to each other.

A mounting portion 26 is provided at the front end of the support portion 20 to which the stylus 4 can be attached and detached. A mounting member 28 is provided at the center of the front face of the mounting portion 26, and the stylus 4 is secured to the mounting member 28. A female thread in the mounting member 28 and a male thread at the base of the stylus 4 are screwed together, and the stylus 4 is fastened to the mounting member 28.

In this configuration, the stylus 4 rotates together with the support member 6 with the bearing 8 (“first fulcrum P1” described below) as a base point by the resistance (pressing force) when the contactor 7 contacts the measurement target. This rotational displacement of the stylus 4 is converted into the axial displacement of the scale in the case 2, which is detected by the sensor (see below for details).

The fastening force of the support portion 20 to the joint portion 18 by the screw 24 is set to be greater than the resistance force when the stylus 4 contacts the measurement target and smaller than the fastening force of the joint portion 18 to the connection portion 16 by the screw 22. In other words, the user can change the mounting angle (relative angle) of the support portion 20 to the joint portion 18 from the reference position shown in FIG. 2 as needed, and the measuring instrument 100 can function properly even after the change. The mounting angle may be changed according to the purpose of the displacement detection device 1, the shape of the measurement target, or other factors (see details below).

As shown in FIG. 4, the cylinder 10 has a hollow cylindrical shape and is fixed to the case 2. The cylinder 10 is arranged so that the axis L3 of the cylinder 10 is perpendicular to the rotation axis L1. The first fulcrum P1 is located on the rotation axis L1. The position of the first fulcrum P1 in the measuring instrument 100 does not change. When the stylus 4 is in the reference position described above, the axis L2 of the stylus 4 and the axis L3 of the cylinder 10 coincide. Within the cylinder 10, there are provided a shaft 32 extending along the axis L3, a support portion 34 supporting the shaft 32 in the axial direction in a displaceable manner, and a connecting member 36 connecting the shaft 32 and the connection portion 16. The axis L3 is also the axis of the shaft 32.

The support portion 34 is a finite stroke bearing in the present embodiment. Since this bearing is a preloaded ball bearing (rolling bearing), there is no rattling between it and the shaft 32, ensuring the straightness of the shaft 32. It also eliminates hysteresis as the shaft 32 moves back and forth, providing stable guidance for the shaft 32.

The connecting member 36 includes a body 40 supported by a base member 38 fixed to the cylinder 10, and a rod 42 connecting the body 40 and the connection portion 16. The base member 38 is disc-shaped and is provided to close the front end opening of the cylinder 10. An insertion hole 44 is provided in the center of the base member 38. The body 40 has a stepped cylindrical shape and is supported by a plurality of pins (described below) extending from the base member 38. A sphere 48 is secured to the end of the body 40 opposite the base member 38 in a fitting manner.

The rod 42 is press-fitted along the axis L4 of the body 40 and secured to the body 40. The tip portion of the rod 42 extends from the body 40, passes through the insertion hole 44, and is connected to the bearing 8 in a manner that the tip portion fits into the connection portion 16 (see below for details). The center P of the sphere 48 is located on the axis L4. In other words, the body 40 holds the sphere 48 on the axis L4.

A receiving portion 50 is fixed to one end of the shaft 32. The receiving portion 50 has an inverted conical receiving surface 52. The sphere 48 is received in the receiving portion 50 while contacting the receiving surface 52. The receiving surface 52 is tapered and has an inclination angle a (30 degrees in the present embodiment) with respect to a reference line perpendicular to the axis L3 of the shaft 32.

A scale 54 is provided at the other end of the shaft 32 (i.e., the end opposite the sphere 48). The shaft 32, the receiving portion 50, and the scale 54 are arranged along the axis L3.

A ring-shaped spring receiver 55 is provided at the other end of the cylinder 10, and a spring 57 is provided between the receiving portion 50 and the spring receiver 55. The spring 57 urges the receiving portion 50 and thus the shaft 32 forward, i.e., toward the sphere 48 (i.e., opposite the side into which the shaft 32 is pushed during measurement). This urging force of the spring 57 can connect the connecting member 36, the sphere 48, the receiving portion 50, and the scale 54 and displace them in the axial direction of the shaft 32. In particular, the first transmission member, which is the assembly of the connecting member 36 and the sphere 48, and the second transmission member, which is the assembly of the receiving portion 50, the shaft 32, and the scale 54, are in contact with each other and can be displaced in the direction of the axis L3 while being relatively displaced in a direction perpendicular to the axis L3. The stylus 4 can be returned to its reference position after displacement measurement.

In other words, when the stylus 4 contacts the measurement target W during measurement, the stylus 4 can rotate in the vertical (or up/down) and horizontal (or left/right) directions from the initial position (see below) together with the support member 6 with the first fulcrum P1 as a basepoint against the force of the spring 57. On the other hand, when the stylus 4 is detached from the object W after measurement, the stylus 4 can be quickly returned to its initial position by the urging force of the spring 57.

The scale 54 is exposed to the outside of the cylinder 10. A sensor 56 is provided inside the case 2. The scale 54 and the sensor 56 constitute a so-called linear scale (linear encoder). The sensor 56 is a magnetic sensor and is positioned to face the pattern (magnetization pattern) of the scale 54. With this configuration, the sensor 56 reads the pattern of scale 54 as position information when the shaft 32 is displaced. The detection signal of the sensor 56 is output to the information processing device 102 via a communication line 58.

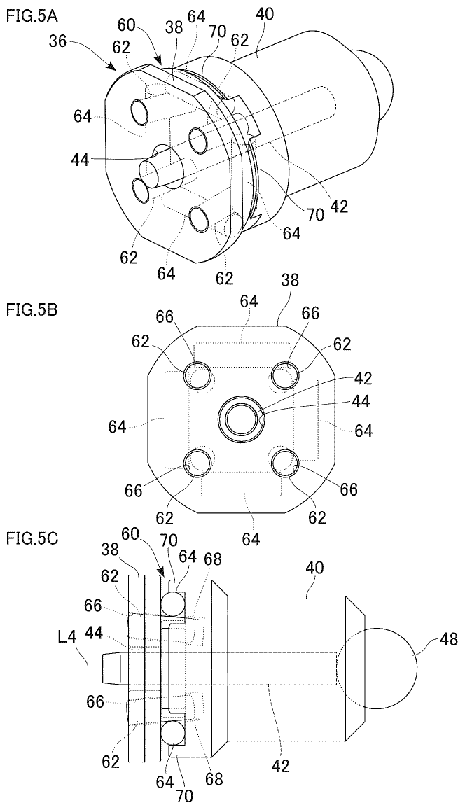

FIGS. 5A to 5C illustrate the configuration of the connecting member 36 in detail. FIG. 5A is a perspective view, FIG. 5B is a front view, and FIG. 5C is a side view.

As shown in FIG. 5A, the connecting member 36 has a tilting mechanism 60 for tilting the body 40 with respect to the base member 38. The tilting mechanism 60 includes four pins 62 provided on the base member 38 and four pins 64 provided on the body 40. The pins 62 are fixed to the base member 38 while passing through the base member 38 in an axial direction. The pins 64 are fixed to the front end face of the body 40.

As also shown in FIG. 5B, an insertion hole 44 is provided in the center of the base member 38, through which the rod 42 passes coaxially. Four through-holes 66 are provided in the base member 38 centering the insertion hole 44, and each of the pins 62 is inserted and secured in each of the through-holes 66. The four through-holes 66 are provided at the positions of the vertices of a virtual square centered on the insertion hole 44, respectively.

As also shown in FIG. 5C, each of the pins 62 is provided at a slight inclination so that it gradually approaches the axis L4 toward the rear (toward the sphere 48 side). In other words, the angle of the through-hole 66 is set as such. The body 40 is provided with insertion holes 68 on the side facing each of the pins 62 to allow insertion of the pins 62. The inner diameter of the insertion hole 68 is sufficiently larger than the outer diameter of the pin 62.

As shown in FIG. 5A, walls 70 are provided on the upper, lower, left, and right outer edges of the front end face of the body 40, and pins 64 are disposed and fixed inside each of the walls 70. Each of the pins 64 is parallel to the front end face of the body 40. The two pins 64 on the top and bottom are parallel to each other, and the two pins 64 on the left and right are parallel to each other.

As also shown in FIG. 5B, the four pins 62 are each located inside a corner of the square area formed by the four pins 64. As also shown in FIG. 5C, each of the pins 62 is in contact with the two pins 64 forming that corner. This configuration allows the tilting mechanism 60 to function as described below.

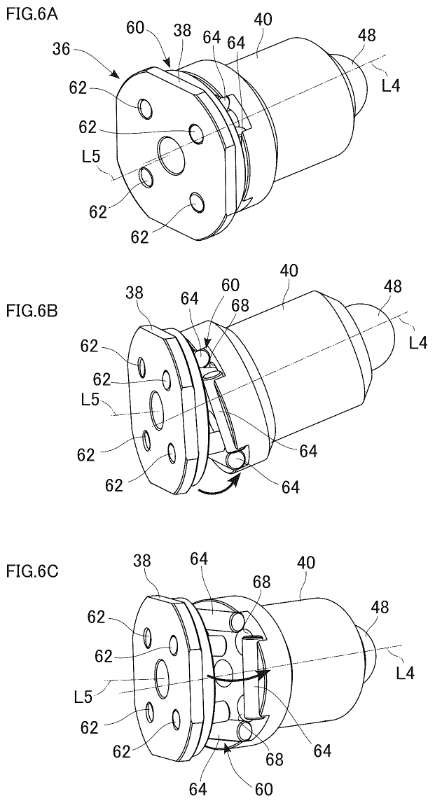

FIGS. 6A to 6C illustrate the action of the tilting mechanism 60. FIG. 6A shows the tilting mechanism 60 not acting, FIG. 6B shows the tilting mechanism 60 acting in a vertical direction, and FIG. 6C shows the tilting mechanism 60 acting in a horizontal direction. In these figures, the rod 42 is omitted for convenience.

As shown in FIG. 6A, in the state where the tilting mechanism 60 is not acting, the axis L5 of the base member 38 and the axis L4 of the body 40 coincide. As shown in FIG. 4, since the base member 38 is fixed to the cylinder 10, its axis L5 coincides with the axis L3 of the shaft 32.

On the other hand, when the tilting mechanism 60 acts in a vertical direction as shown in FIG. 6B, either the upper or lower pin 64 becomes a fulcrum (the second fulcrum P2: see FIG. 4), and the body 40 tilts with respect to the axis L5. Specifically, when the connecting member 36 is tilted upward, the upper pin 64 that is in contact with the base member 38 functions as the second fulcrum P2, and the body 40 tilts upward with the second fulcrum P2 as a base point. This moves the sphere 48 upward. At this time, the upper two pins 62 remain pushed into the insertion holes 68, respectively. On the other hand, as the lower pin 64 is separated from the base member 38, the lower two pins 62 exit the insertion holes 68. Conversely, when the connecting member 36 is tilted downward, the lower pin 64 contacting the base member 38 functions as the second fulcrum P2, and the body 40 tilts downward with the second fulcrum P2 as a base point. This moves the sphere 48 downward. Thus, the respective positions of the plurality of the second fulcrums P2 in the measuring instrument 100 do not change, but each of the pins 64 is displaced according to the action of the tilting mechanism 60. Each of the second fulcrums P2 (see FIG. 4), overlapping the pin 64, functions as the center of rotation (base point of tilt) of the tilting mechanism 60.

When the tilting mechanism 60 acts in a horizontal direction as shown in FIG. 6C, one of the pins 64 on the left or right acts as the fulcrum (the second fulcrum) and the body 40 tilts with respect to the axis L5. Specifically, when the connecting member 36 is tilted to the left, the pin 64 on the left side that is in contact with the base member 38 functions as the second fulcrum, and the body 40 tilts to the left with that second fulcrum as a base point. This moves the sphere 48 to the left. At this time, the two pins 62 on the left side remain pushed into the insertion holes 68, respectively. On the other hand, as the right side pin 64 is separated from the base member 38, the two pins 62 on the right side exit the insertion holes 68. Conversely, when the connecting member 36 is tilted to the right, the right side pin 64 contacting the base member 38 functions as the second fulcrum, and the body 40 tilts to the right with that second fulcrum as a base point. This moves the sphere 48 to the right. This configuration allows the stylus 4 to be displaced in both the vertical and horizontal directions, as shown by the dotted arrows in FIG. 2. As a result, the vertical and horizontal displacements of the measurement target can be measured. The action of the tilting mechanism 60 described above is related to the offset function, which is described below, and thus to the function of the displacement amplification mechanism.

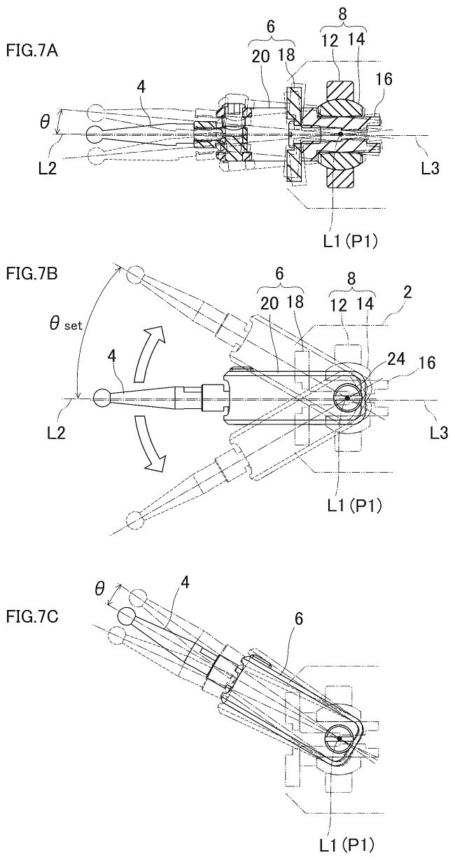

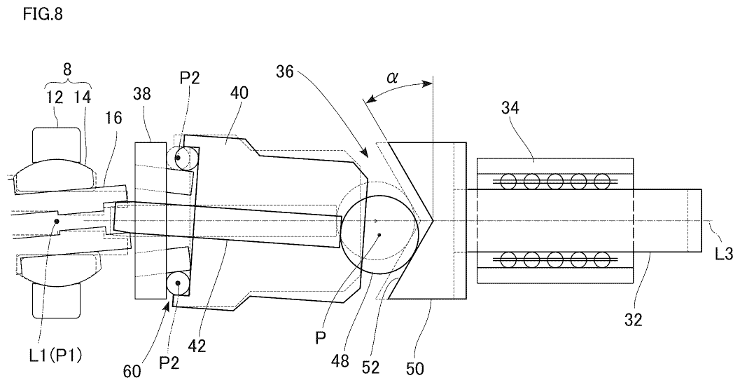

FIGS. 7A to 7C illustrate the configuration and action of the stylus 4 and its surroundings. FIG. 7A shows the action of the stylus 4 during displacement detection. FIGS. 7B and 7C show how the angle of the stylus 4 is adjusted.

As described above, the stylus 4 is fixed to the support portion 20 of the support member 6, and the joint portion 18 of the support member 6 is fixed to the connection portion 16. The connection portion 16 is fixed to the inner ring 14 of the bearing 8. Therefore, as shown in FIG. 7A, the stylus 4, together with the support member 6, rotates about the rotation axis L1 with the bearing 8 (the first fulcrum) as a base point. The rotation axis L1 is perpendicular to the axis L3 of the shaft 32. The axis L2 of the stylus 4 makes an angle θ with the axis L3 according to its rotation.

As mentioned above, the initial position (initial angle) of the stylus 4 can be changed according to the application of the displacement detection device 1 and the shape of the measurement target. As shown in FIG. 7B, the angle of the support portion 20 with respect to the joint portion 18, i.e., the initial angle θset of the stylus 4, can be changed around the screw 24. This initial position (initial angle) is also the initial position (initial angle) of the shaft 32 relative to the axis L3. In other words, a pivoting mechanism of the stylus 4 with respect to the case 2 is implemented. By re-tightening the screw 24 after the change, the stylus 4 will rotate with respect to the changed initial angle θset, as shown in FIG.

7C.

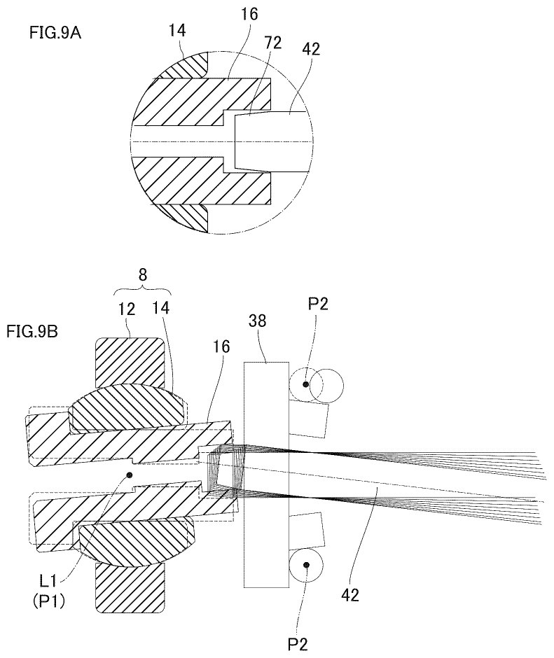

Even if the initial angle θset is set to an angle other than 0 degrees, the center of rotation of the stylus 4 will remain unchanged with the rotation axis L1, i.e., the base point of rotation remains at the bearing 8 (the first fulcrum). The fulcrum of the stylus 4 will be at a position away from the connection point between the connection portion 16 and the rod 42 (see FIG. 9B). Therefore, the measurement error does not increase.

Next, the actuation conversion mechanism and displacement amplification mechanism of the present embodiment will be described.

The measuring instrument 100 includes an actuation conversion mechanism that converts the rotation of the stylus 4 into the axial motion of the shaft 32 and a displacement amplification mechanism that amplifies the displacement of the shaft 32 according to the rotation of the stylus 4. These actuation conversion mechanism and displacement amplification mechanism constitute a displacement transmission mechanism that amplifies the displacement of the stylus 4 and transmits it to the shaft 32 and thus the scale 54. The mechanism is described below.

FIG. 8 schematically illustrates the actuation conversion mechanism and the displacement amplification mechanism. FIGS. 9A and 9B schematically illustrate a second amplification mechanism that constitutes the displacement amplification mechanism. FIG. 9A is an enlarged view of section B in FIG. 4. FIG. 9B illustrates the configuration and action of the second amplification mechanism.

As shown in FIG. 8, when the connection portion 16 rotates together with the stylus 4, the rod 42 is tilted to the opposite side of the connection portion 16 and pushed slightly in the axial (backward) direction.

In particular, as shown in FIG. 9A, the connection portion 16, which has a stepped cylindrical shape, has a recessed fitting portion 71 that receives the tip portion of the rod 42. On the other hand, the outer circumference of the tip portion of the rod 42 has an inclined surface 72 (tapered surface) that decreases in diameter toward the tip. This allows the rod 42 to rotate without locking when the stylus 4 is rotated as shown in FIG. 9B. The rod 42 is displaced slightly backward (to the right in the figure) with respect to the connection portion 16 while rotating with the second fulcrum P2 as a base point.

Returning to FIG. 8, since the body 40 integrated with the rod 42 is also inclined at this time, the sphere 48 moves on the receiving surface 52 of the receiving portion 50, and its center P is offset from the axis L3 of the shaft 32. At this time, the connecting member 36 rotates around the second fulcrum P2, which is offset from the axis L3, thereby pushing the receiving surface 52 backward in the axial direction (to the right in the figure) significantly. This increases the displacement amount of the receiving portion 50 pushed backward (to the right in the figure).

In this way, the rotation of the stylus 4 is converted into the axial motion of the shaft 32, and the displacement of the shaft 32 according to the rotation is amplified. In other words, this series of mechanisms functions as an actuation conversion mechanism, an offset mechanism, and a displacement amplification mechanism.

The displacement amount caused by the displacement amplification mechanism can be increased by increasing the inclination angle α of the receiving surface 52. However, the larger the inclination angle α, the greater the resistance to the movement of the sphere 48, making it difficult for the offset mechanism to function. As this resistance increases, the force exerted on the stylus 4 from the measurement target (measuring force) also increases, which may cause problems such as heavier measurement operations. For this reason, the inclination angle α is preferably 20 to 40 degrees, more preferably 20 to 30 degrees, and in the present embodiment, the inclination angle α is set at 30 degrees.

As the displacement amplification mechanism, not only the relative displacement between the sphere 48 and the receiving surface 52 (see FIG. 8) but also the relative displacement between the connection portion 16 and the rod 42 (see FIG. 9B) contributes. Therefore, the displacement amplification mechanism of the embodiment can be said to include a first amplification mechanism implemented by the sphere 48 and the receiving surface 52 and a second amplification mechanism implemented by the connection portion 16 and the rod 42. In the present embodiment, the shaft 32 and thus the scale 54 is displaced to the same or greater extent as the vertical displacement of the stylus 4.

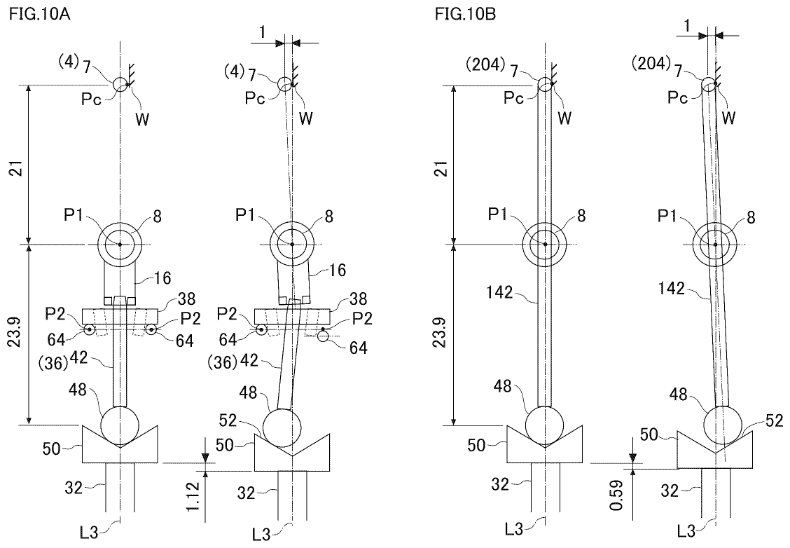

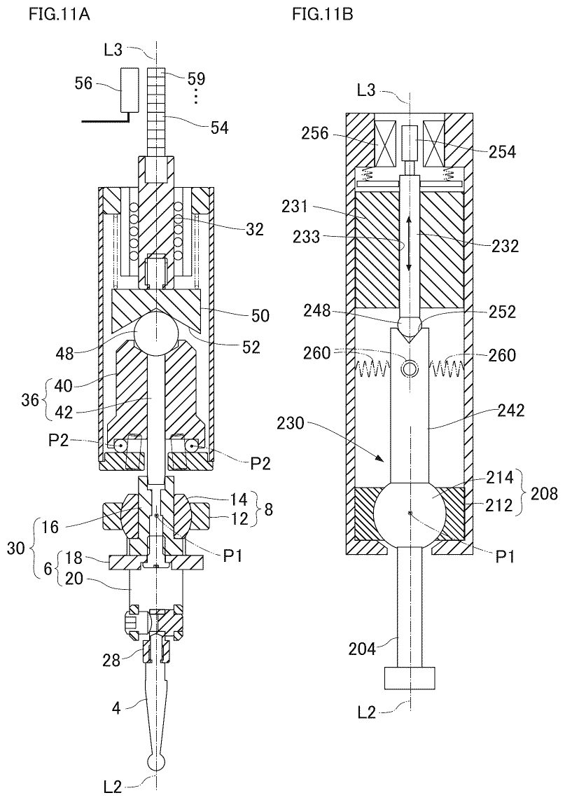

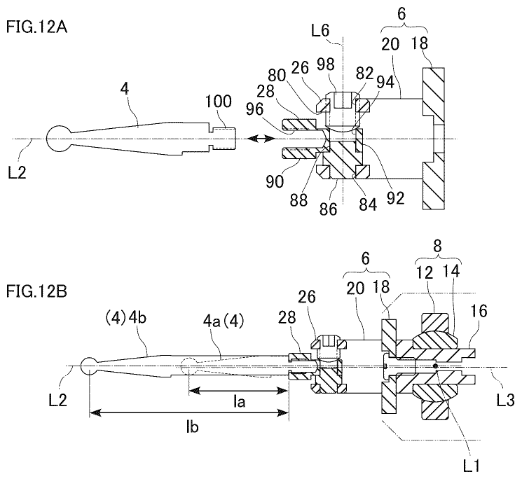

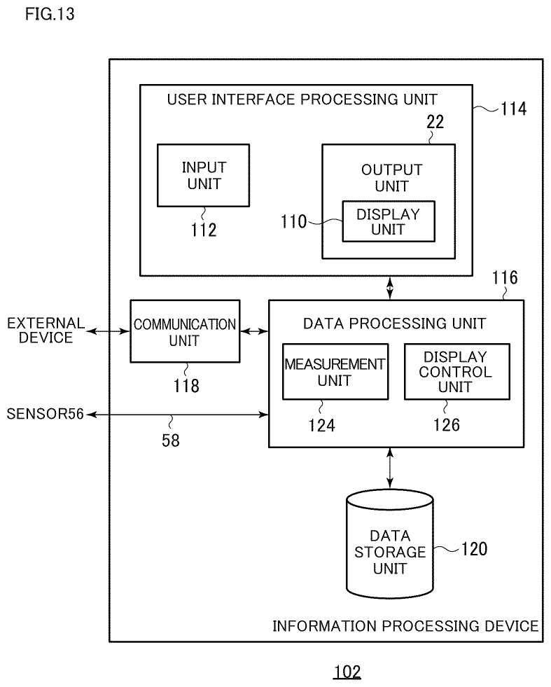

FIGS. 10A and 10B schematically illustrate the principle of displacement amplification. FIG. 10A shows the principle of the embodiment, and FIG. 10B shows the principle of Comparative Example 1.

The left portion of FIG. 10A shows the state of the stylus 4 just before the stylus 4 contacts the measurement target W. The right portion of FIG. 10A shows the state after the stylus 4 contacts the measurement target W. In the present embodiment, the displacement transmission mechanism transmits the displacement of the stylus 4 caused by the contactor 7 contacting the measurement target W to the shaft 32. The displacement transmission mechanism has the first fulcrum P1 and the second fulcrum P2. This displacement transmission mechanism transmits the displacement of the stylus 4 to the shaft 32 according to the rotation of the stylus 4.

As shown in the right portion of FIG. 10A, the connecting member 36 rotates with the second fulcrum P2 as a base point, which is provided closer to the shaft 32 than the first fulcrum P1. The first fulcrum P1 is located on the axis L3 of the shaft 32, while the second fulcrum P2 is offset from the axis L3 of the shaft 32. The displacement amplification mechanism rotates the connecting member 36 with the second fulcrum P2 as a base point according to the rotation of the stylus 4 with the first fulcrum P1 as a base point. At this time, the connecting member 36 is pushed in the axial direction of the shaft 32 while rotating about the second fulcrum P2. As a result, the sphere 48 moves on the slope (the receiving surface 52) of the receiving portion 50 while being pushed in the axial direction of the shaft 32. The deflection angle of the rod 42 relative to the displacement of the stylus 4 also increases. As a result, the axial displacement of the shaft 32 increases. In other words, according to the rotation of the stylus 4 with the first fulcrum P1 as a base point, the connecting member 36 is pushed toward the shaft 32 while being displaced relative to the stylus 4 in the axial direction of the shaft 32. Furthermore, according to the rotation of the stylus 4, the connecting member 36 rotates with the second fulcrum P2 as a base point, and the shaft 32 is pushed in while being displaced relative to the connecting member 36 in the axial direction.

According to the present embodiment, by rotating the connecting member 36 with the second fulcrum P2 as a base point, which is located offset from the axis L3, the shaft 32 can be pushed in further while pushing in the sphere 48 itself. For example, in a case with the dimensions (mm) shown in the figure, when the displacement of the stylus 4 (displacement of the contact point Pc with the measurement target W) is 1 mm, the axial displacement of the shaft 32 (displacement of the scale 54) is 1.12 mm.

The left portion of FIG. 10B shows the state of the stylus 204 just before the stylus 204 contacts the measurement target W in Comparative Example 1. The right portion of FIG. 10B shows the state after the stylus 204 contacts the measurement target W. As shown in the left portion of FIG. 10B, Comparative Example 1 has the first fulcrum P1 but does not have the second fulcrum P2. The rod 142, to which the sphere 48 is fixed at the tip, and the stylus 204 are composed in one piece and rotate with the first fulcrum P1 as a base point. As shown in the right portion of FIG. 10B, this configuration does not provide the displacement amplification effect like the present embodiment because the sphere 48 itself is not pushed in when the stylus 204 is displaced. For example, in a case with the dimensions (mm) shown in the figure, when the displacement of the stylus 204 (displacement of the contact point Pc with the measurement target W) is 1 mm, the axial displacement of the shaft 32 (i.e., displacement of the scale 54) is 0.59, which is smaller than the present embodiment.

In other words, according to the present embodiment, the displacement of the scale relative to the displacement of the stylus can be greater (i.e. amplified) than in Comparative Example 1 by providing the two fulcrums (the first fulcrum P1 and the second fulcrum P2).

FIGS. 11A and 11B schematically illustrate the differences in configuration and action between the embodiment and a comparative example. FIG. 11A shows the configuration of the embodiment and FIG. 11B shows the configuration of Comparative Example 2.

As shown in FIG. 11A, in the embodiment, the support member 6 and the connection portion 16 constitute the rotating member 30, which rotates with the first fulcrum P1 located at the center of the bearing 8 as a base point. The scale 54 has a periodically magnetically recorded pattern 59 (magnetization pattern) in the longitudinal direction of the shaft 32. The sensor 56 detects the displacement of the scale 54 (displacement of the pattern 59) caused by a vertical or horizontal rotation of the stylus 4.

Since multiple types of styli 4 with different lengths can be attached to and detached from the rotating member 30, the stylus 4 can be exchanged according to the measurement target or the point to be measured. When the length of the stylus 4 is changed due to the replacement, the correction described below must be performed; this correction can be performed relatively easily because the same measuring scheme is used in which the sensor 56 reads the displacement of the stylus 4 as the displacement of the pattern 59.

In Comparative Example 2, on the other hand, a stylus 204 and a rod 242 are connected coaxially via an inner ring 214 of a bearing 208. The bearing 208 is a spherical bearing and includes an annular outer ring 212 and an inner ring 214 with a spherical outer surface. The fulcrum P1 is located at the center of the bearing 208. The stylus 204, the inner ring 214, and the rod 242 are fixed together and constitute the rotating member 230. In other words, the stylus 204 is not detachable from the rotating member 230.

In Comparative Example 2, a receiving surface 252 is provided at the end of the rod 242, and a sphere 248 is provided at one end of the shaft 232. The shaft 232 is inserted into a guide hole 233 formed through a cylindrical member 231 and is supported slidably in the axial direction. Four springs 260 (radial urging means for returning the tilt of the rotating member 230 to its initial state) are provided to urge the rod 242 in the radial direction (perpendicular to the axis line).

Comparative Example 2 differs from the present embodiment in that the displacement amount of the shaft 232 is detected by a differential transformer consisting of a core 254 and a coil 256. The core 254 is provided at the other end of the shaft 232. As the core 254 is displaced by the rotation of the stylus 204, the impedance of the coil 256 changes in accordance with the displacement amount, and the output signal level changes. By detecting this change in output signal level, the displacement of the stylus 204 can be measured. In Comparative Example 2, unlike the configuration that detects the displacement of the pattern as in the current embodiment, it is difficult to obtain linearity between the displacement of the stylus 204 and the detected value (impedance), so that compensation as the length of the stylus 204 changes is not easy, and stylus replacement is difficult in the first place.

FIGS. 12A and 12B illustrate the details of the attachment/detachment structure of a stylus 4. FIG. 12A shows the mounting structure of the stylus 4 and the support member 6. FIG. 12B illustrates how the stylus 4 is replaced.

As shown in FIG. 12A, a vertical axis L6 is set in the center of the front end of the support portion 20 in the support member 6, and an opening 80 is provided that opens in the front-rear direction. The upper and lower portions of the mounting portion 26, where the opening 80 is located, are provided with through holes 82 and 84 along the axis L6, respectively.

A core member 86 is fixed coaxially with the lower through hole 84. The core member 86 has a stepped cylindrical shape and its upper portion constitutes a fitting portion 88. On the other hand, the mounting member 28 has an attaching/detaching portion 90 to which the stylus 4 is attached and detached, and a connection portion 92 connected to the core member 86. Through the connection portion 92, a fitting hole 94 of complementary shape to the fitting portion 88 is formed. The attaching/detaching portion 90 is provided with a female thread 96 along the axis L2.

With the connection portion 92 fitted to the core member 86, a screw 98 is screwed into the through hole 82. The lower surface of the screw 98 has a spherical shape and is autonomously aligned by being pressed against the upper end of the fitting hole 94. By tightening the screw 98 in this state, the screw 98 is secured to the mounting portion 26. As a result, the mounting member 28 is also secured to the mounting portion 26 in a manner that it is sandwiched between the core member 86 and the screw 98.

In this state, the stylus 4 is attached to the mounting member 28. The base of the stylus 4 is provided with a male thread 99 corresponding to the female thread 96. By screwing the male thread 99 into the female thread 96, the stylus 4 is fastened to the mounting member 28. As a result, the stylus 4 can be secured to the mounting portion 26 and thus to the support member 6. The stylus 4 can also be removed from the mounting portion 26 by loosening the screws.

The joint between the stylus 4 and the mounting member 28 is standardized so that multiple types of styli 4 of different lengths can be attached and detached. Specifically, the shapes of the base ends of multiple types of styli 4 are standardized. As a result, as shown in FIG. 12B, a shorter stylus 4a (length la) or a longer stylus 4b (length lb) can be attached, depending on the measurement target or measurement point.

However, when the length of the stylus 4 is changed in this way, the correspondence between the displacement of the stylus 4 and the displacement of the shaft 32 during the measurement changes, so that the detected value must be corrected. This correction method is described below.

FIG. 13 is a functional block diagram of the information processing device 102.

Each component of the information processing device 102 is implemented by hardware including computing units such as central processing units (CPUs) and various computer processors, a storage device such as memories and storages, and wired or wireless communication lines that connects these units and devices, and software that is stored in the storage devices and supplies processing instructions to the computing units. Computer programs may be constituted by device drivers, operating systems, various application programs on upper layers thereof, and a library that provides common functions to these programs. Each of the blocks described below represents a functional block, not a hardware block.

The information processing device 102 includes a user interface processing unit 114, a data processing unit 116, a communication unit 118, and a data storage unit 120.

The user interface processing unit 114 is responsible for processing related to the user interface, such as image display and audio output, in addition to accepting operations from the user. The communication unit 118 is responsible for wireless or wired communication with external devices. The data processing unit 116 executes various processes based on data acquired by the user interface processing unit 114 and the communication unit 118, information detected by the sensor 56, and data stored in the data storage unit 120. The data processing unit 116 also functions as an interface to the user interface processing unit 114, the communication unit 118, and the data storage unit 120. The data storage unit 120 stores various programs and setting data.

The user interface processing unit 114 includes an input unit 112 and an output unit 122.

The input unit 112 accepts input from the user via the touch panel on the monitor 106. The output unit 122 includes a display unit 110. The display unit 110 displays various images.

The data processing unit 116 includes a measurement unit 124 and a display control unit 126.

The measurement unit 124 measures the displacement amount of the stylus 4 based on the information detected by the sensor 56, and thus measures the displacement amount of the measurement target. The display control unit 126 generates an image and displays it on the display unit 110.

Next, the method of correcting the measurement values will be described.

Although the above measuring instrument 100 can be used measure the displacement and length of the measurement target, since the measurement is made using a mechanical structure, slight errors can occur between the measurement value and the actual value. Therefore, the information processing device 102 compensates for this error. The data storage unit 120 stores a correction coefficient for this error. The measurement unit 124 corrects the measurement value based on this correction coefficient and stores it in the data storage unit 120.

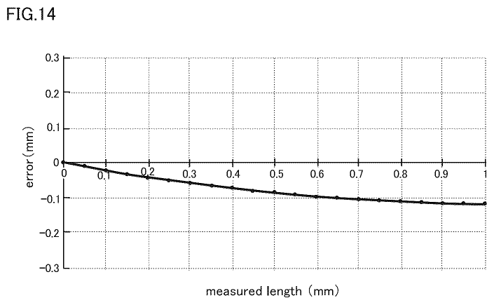

FIG. 14 is a graph illustrating an example of an error between length measured by the measuring instrument 100 and the actual length.

In this example, the measurement length becomes shorter than the actual length, and the longer the measurement length, the grater the error. Therefore, based on this trend, the measurement unit 124 sets a correction coefficient to bring the error closer to zero according to the measurement length. This allows for more accurate measurement values. In this embodiment, it is sufficient to apply an almost linear correction.

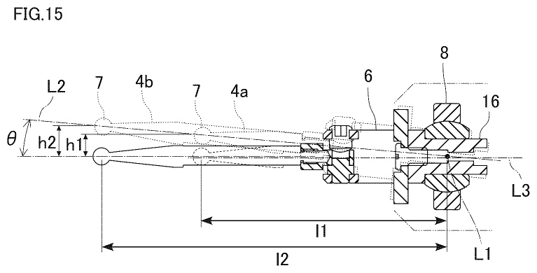

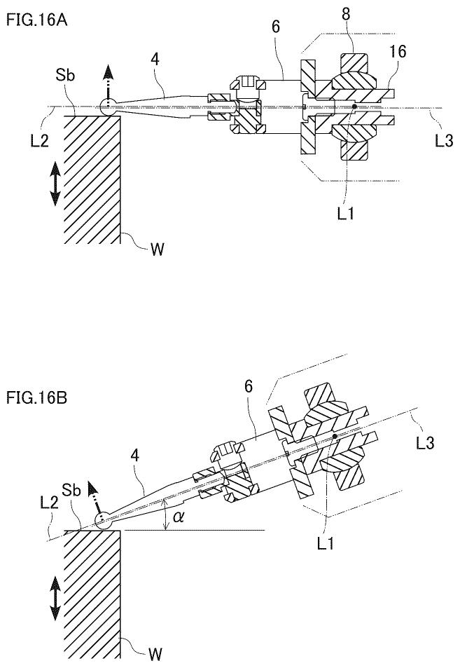

FIG. 15 is a view illustrating a correction method performed during the replacement of the stylus 4.

The distance from the rotation axis L1 to the contactor 7 when using the stylus 4a is different from that when using the stylus 4b (12>11). Therefore, the detected displacement in the direction of rotation (displacement in the height direction) will be different (h2>h1) even if the angle of rotation θ, which affects the displacement of the shaft 32, is the same.

Therefore, when the user replaces the stylus 4, the user enters the length of the stylus 4 after the replacement via the touch panel on the monitor 106. The measurement unit 124 sets a correction coefficient according to that stylus 4 length and stores it in the data storage unit 120. For example, if the measurement with the stylus 4a is set as the standard (correction coefficient=1), the correction coefficient k (=h1/h2) is set when the stylus 4b is used. The measurement unit 124 corrects the measurement value using that correction coefficient when measuring with the measuring instrument 100, and displays the corrected measurement value on the display unit 110. This allows errors to be corrected and detection accuracy to be maintained.

FIGS. 16A and 16B illustrate a correction method for stylus angular error.

As shown in FIG. 16A, at the start of measurement, the stylus 4 is preferably placed parallel (in the example in FIG. 16A, horizontal as with the top surface of the measurement target W) to the reference surface Sb (the surface at the reference position for displacement) of the measurement target W. t this time, the direction of displacement of the stylus 4 generally coincides with the direction of displacement of the measurement target W (see the double-dashed arrow). Therefore, the measurement value measured by the measuring instrument 100 corresponds to the displacement of the measurement target W.

On the other hand, as shown in FIG. 16B, when the stylus 4 is placed at an angle a to the reference plane Sb at the start of measurement, the direction of displacement of the stylus does not coincide with the direction of displacement of the measurement target W (see double-dashed arrow). Therefore, the displacement of the measurement target W is the measurement value of the measuring instrument 100 multiplied by cos α.

Therefore, when the stylus 4 is set at an angle α to the reference plane Sb, the user enters the angle α of the stylus 4 via the touch panel of the monitor 106. The correction coefficient corresponding to the angle α is stored in advance in the data storage unit 120. The measurement unit 124 sets the correction coefficient corresponding to the angle α of the stylus 4. The measurement value is corrected using that correction coefficient when measuring with the measuring instrument 100, and the corrected measurement value is displayed on the display unit 110. This allows errors to be corrected and detection accuracy to be maintained.

As explained above, according to the displacement detection device 1 of this embodiment, the stylus 4 is detachably attached to the support member 6. Therefore, by replacing with the stylus 4 with a stylus of a different length according to the shape of the measurement target or the measurement point, it is possible to bring the stylus into contact with a measurement target according to the structure of the measurement target, ensure measurement accuracy, and perform displacement detection appropriately. If the stylus 4 is damaged, only the stylus 4 needs to be replaced with a new one, and the case 2 and internal mechanism can continue to be used without replacement, thereby suppressing running costs.

In addition, by forming the support portion 20 of the support member 6 into an arch shape and assembling it to the outside of the case 2, the case 2 can be made compact, e.g., by making the width of the case 2 as small as necessary. In particular, when a spherical bearing is used as the bearing 8 as in the above embodiment, it is difficult to fit the base end of the support member 6 inside the case 2 because the bearing itself occupies a large width. In this regard, by placing both ends of the arched portion of the support portion 20 on the outer surface of the case 2, the problem of space occupation within the case 2 is eliminated.

Furthermore, by making the mounting angle of the support portion 20 to the case 2 variable, the initial angle of the stylus 4 can be flexibly adjusted according to the shape of the measurement target and the measurement point. This allows the stylus 4 to be brought into contact with the measurement target without interfering with surrounding structures. As a result, measurement accuracy can be ensured and displacement detection can be performed appropriately.

In addition, since the displacement of the shaft 32 according to the rotation of the stylus 4 is amplified by the mechanism as explained above, there is no need for electrical amplification. Therefore, the measurement results can be directly reflected, and the detection accuracy can be maintained at a high level. In other words, the displacement of the measurement target can be detected with high accuracy.

Furthermore, since the displacement amplification mechanism can be implemented with a simple mechanism mainly including the connecting member 36, the sphere 48, and the receiving portion 50, the displacement amplification mechanism can be configured in a relatively compact manner, which is advantageous in terms of cost and suppresses problems such as malfunctions. Because a bearing is employed as the support portion 34, resistance to displacement of the shaft 32 in the axial direction can be reduced. Therefore, the load of the spring 57 for return can also be kept small. Although the stylus 4 can be displaced vertically and horizontally during measurement in this embodiment, it is sufficient to have an axial urging means of urging the stylus 4 in the axial direction of shaft 32 (load by the spring 57) to return the stylus 4 to its initial position after measurement. For example, a spring that urges the connecting member 36 in the radial direction (perpendicular to the axis) (a radial urging means to return the tilt to the initial state) is not necessary. These factors allow the compact design of the displacement detection device 1.

### MODIFICATIONS

As shown in FIGS. 12A and 12B, the above embodiment illustrates a configuration in which the stylus 4 is attached to and detached from the mounting member 28 fixed to the support member 6 when the stylus 4 is replaced. In a modification, the stylus 4 may be replaced by attaching and detaching the mounting member 28, to which the stylus 4 is pre-assembled, to and from the support member 6. Loosening the screw 98 enables such replacement. However, in such a case, the mounting angle of the mounting member 28 to the support member 6 must be readjusted, which may complicate the work. Therefore, it is preferable to leave the mounting member 28 fixed in the proper position with respect to the support member 6 and replace only the stylus 4.

In the above embodiment, the screw 98 is detachable from and attachable to the mounting portion 26. In a modification, e.g., a pin may be employed in place of the screw 98 and secured to the mounting portion 26 by caulking or other fastening means.

As shown in FIG. 4, the above embodiment illustrates a configuration in which the sphere 48 is provided on the connecting member 36 side and the receiving portion 50 is provided on the shaft 32 side. Conversely, in a modification, the receiving portion may be provided on the connecting member side and the sphere on the shaft side. In other words, the sphere may be kept on the shaft axis while the receiving part side is inclined to function as a displacement amplification mechanism.

The above embodiment illustrates a configuration in which the four pins 62 extending from the base member 38 and the four pins 64 (two pairs of parallel pins) provided on the body 40 are used as fulcrum components to implement the tilting mechanism 60. In a modification, a sphere (ball) may be employed in place of one or both of the pins 62 and pins 64. Alternatively, a projection may be employed. The configuration is sufficient such that the fulcrum component on the base member side and the fulcrum component on the body side make point contact (contact at two points) for the action of the tilting mechanism.

The fulcrum component on the base member side and the fulcrum component on the body side may both be in the form of an O-ring so that the tilting mechanism can tilt not only in the vertical and horizontal directions but also at an arbitrary angle.

In the above embodiment, an example is shown in which the sensor 56 is a magnetic sensor. In a modification, an optical sensor, a capacitive sensor, an analog sensor such as a differential transformer using a coil or other sensors may be used.

In the above embodiment, a finite stroke bearing is employed as the support portion 34, but it may be a ball bearing without preload. In a modification, the support portion may be configured with a sliding bearing. Since a rolling bearing has lower friction than a plain bearing, the resistance to displacement of the shaft 32 can be reduced. Therefore, the sensitivity of the stylus 4 can also be increased by keeping the load of the spring 57 small. It is also possible to quickly return the stylus 4 to its initial position when the stylus 4 is detached from the measurement target W. Alternatively, the support portion may be composed of a cylindrical member or the like without a bearing, and the shaft 32 may be slidably inserted and guided in the axial direction.

In the above embodiment, an inverted conical slope is employed as the receiving surface 52 of the receiving portion 50, but an arc-shaped slope may also be used. This allows the curve profile shown in FIG. 14 to be corrected by shape rather than electrically.

The present invention is not limited to the embodiment described above and modifications thereof, and any component thereof can be modified and embodied without departing from the scope of the invention. Components described in the embodiment and modifications can be combined as appropriate to form various embodiments. Some components may be omitted from the components presented in the embodiment and modifications.

This application claims priority from Japanese Patent Application No. 2022-143592 filed on Sep. 9, 2022 and Japanese Patent Application No. 2023-136327 filed on Aug. 24, 2023, the entire contents of which are hereby incorporated by reference herein.

1. A displacement detection device, comprising:
a stylus;
a rotating member that supports the stylus and rotates with a fulcrum as a base point when the stylus contacts a measurement target;
a shaft on which a scale is provided;
an actuation conversion mechanism that converts the rotation of the rotating member upon contact of the stylus with the measurement target into axial motion of the shaft; and
a sensor that detects displacement of the scale, wherein
the stylus is detachably attached to the rotating member.

2. The displacement detection device according to claim 1, wherein
the shaft is provided with a pattern of the scale in a longitudinal direction,
the sensor detects displacement of the pattern of the scale,
the stylus is capable of rotating with the rotating member in the vertical and horizontal directions with the fulcrum as a base point, and
the sensor is capable of detecting displacement of the pattern of the scale caused by a vertical or horizontal rotation of the stylus.

3. The displacement detection device according to claim 2 wherein
the rotating member comprises:
an arch-shaped support portion extending forward of the case that houses the scale and the sensor; and
a mounting portion provided at the front end of the support portion to which the stylus is capable of being attached and detached.

4. The displacement detection device according to claim 3, wherein the mounting portion interchangeably attaches and detaches multiple types of styli of different lengths.

5. The displacement detection device according to claim 2, further comprising:
a bearing that supports the shaft in the axial direction in a displaceable manner; and
a spring that urges the shaft to the axial direction so as to return the stylus to its initial position when the stylus is detached from the measurement target, wherein
the stylus is capable of rotating in the vertical and horizontal directions from the initial position together with the rotating member with the fulcrum as a base point against the urging force of the spring.

6. The displacement detection device according to claim 5, comprising:
a receiving portion having an inverse conical receiving surface and provided on the axis of the shaft;
a sphere received in the receiving portion so as to contact the receiving surface; and
an offset mechanism that increases the amount of pushing in the axial direction of the shaft by moving the sphere on the receiving surface so that the center of the sphere is offset from the axis of the shaft according to rotation of the rotating member, wherein
the spring urges the receiving portion toward a side opposite to the side in which the shaft is pushed.

7. The displacement detection device according to claim 2, wherein
the rotating member comprises:
a support portion extending forward of the case that houses the scale and the sensor;
a mounting portion provided at the front end of the support portion to which the stylus is attached; and
a joint portion that is fastened to a connection portion provided on an inner ring of a bearing serving as the fulcrum, wherein
an end of the support portion is fastened to the joint portion via a fastening member, and
the axis of the fastening member is located on a rotation axis of the fulcrum.

8. The displacement detection device according to claim 7, wherein the fastening force of the support portion to the joint portion is set to be greater than the resistance force when the stylus contacts the measurement target and smaller than the fastening force of the joint portion to the connection portion.

9. The displacement detection device according to claim 7, further comprising:
a measurement unit that measures the displacement amount of the measurement target based on the detection information of the sensor, wherein
the measurement unit sets a correction coefficient according to the length of the stylus supported by the rotating member, and corrects the measurement value using the set correction coefficient when measuring the displacement amount.

10. The displacement detection device according to claim 7, further comprising:
a measurement unit that measures the displacement amount of the measurement target based on the detection information of the sensor, wherein
the measurement unit sets a correction coefficient according to the angle that the stylus makes with respect to the reference plane of the measurement target, and corrects the measurement value using the set correction coefficient when measuring the displacement amount.
